(19) United States
(12) Patent Application Publication
(10) Pub. No.: US 2005/0164035 A1
(43) Pub. Date: Jul. 28, 2005

(54) Magnetic recording media

(75) Inventors: Byung-kyu Lee, Seoul (KR); Hoon-sang Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/014,239

(22) Filed: Dec. 17, 2004

(30) Foreign Application Priority Data
Dec. 9, 2003 (KR) 10-2003-0093690

(51) Int. Cl. G11B 5/64

(52) U.S. Cl. 428/694 MT; 428/694 MP

(57) ABSTRACT

A magnetic recording medium including a magnetic recording layer containing magnetic crystal grains and a substrate supporting the magnetic recording layer. The magnetic recording layer is composed of a porous crystal isolating membrane having micropores capable of magnetically and physically isolating the magnetic crystal grains. A transition metal element selected from Co, Fe, Ni, Cr, Pt, Pd, Ti, Ta, Ru, Si, Al, Nb, B, Nd, Sm and Pr or an alloy thereof is impregnated into the pores. The magnetic recording medium has superior thermal stability and S/N characteristics.

This application claims the benefit of Korean Patent Application No. 2003-93690, filed on Dec. 19, 2003, in the Korean Intellectual Property Office, the disclosure of which is incorporated herein in its entirety by reference.

### BACKGROUND OF THE INVENTION

1. Field of the Invention

The present invention relates to magnetic recording media capable of producing a high-density information recording and having high thermal stability and superior signal-to-noise ratio (SNR) characteristics.

2. Description of the Related Art

Magnetic recording media may be divided into longitudinal magnetic recording (LMR) media and perpendicular magnetic recording (PMR) media. In LMR media, magnetic recording is performed by forming recording bits parallel to the plane of a magnetic recording medium. In PMR media, magnetic recording is performed by forming recording bits perpendicular to the film plane of a magnetic recording medium having perpendicular magnetic anisotropy. It is known that since PMR has higher magnetostatic energy and lower antimagnetic field energy than a conventional LMR, it is advantageous in obtaining higher recording density.

In both the LMR and the PMR, in order to obtain a high density magnetic recording medium, it is necessary to increase the coercive force of a magnetic substance constituting a magnetic recording layer of the magnetic recording medium to ensure thermal stability. One of the factors that determine the coercive force of the magnetic substance is the magnetic anisotropic energy which relates to the tendency of a magnetic moment in a magnetic crystal grain to align in a specific crystal direction. As the magnetic anisotropic energy increases, the tendency of aligning in a specific crystal direction increases. For example, in the case of a Co crystal grain, the c axis of a hexagonal dense crystal lattice is the direction in which the magnetic moment aligns (magnetization easy axis) and the magnetic anisotropic energy (Ku) is about 4.6×10⁶ erg/cm³. When the volume of a crystal grain is V, the energy causing the magnetic moment in the crystal grain to align with the magnetization easy axis is given as KuV. Meanwhile, the magnetic moment moves due to thermal vibration, which may be represented as the product of Boltzmann's constant K_{B} and absolute temperature T, i.e. K_{B}T. Comparing K_{B}T with KuV, in the case of K_{B}T<<KuV, since the magnetic anisotropic energy is significantly greater than the thermal vibration energy, the magnetic moment aligns with the approximate c axis of the crystal grain. However, in the case of K_{B}T>>KuV, since the thermal vibration energy is greater than the magnetic anisotropic energy, the magnetic moment continues to thermally vibrate, which is called a superparamagnetic phenomenon. In general, when the value of (KuV)/(K_{B}T) is 50-100, thermal stability of a medium can be ensured. When the value of (KuV)/(K_{B}T) is less than 50, magnetic domains of recorded information may be destroyed.

To realize high density recording in the magnetic recording media, it is necessary to reduce noise. To this end, the particle diameter of magnetic crystal grains composing the magnetic recording medium is decreased and the distribution thereof is made to be uniform to reduce noise. Generally, to perform high density recording of 200 Gb/in² or greater, micro-crystal grains of 10 nm or less are required. However, when reducing the particle diameter of a crystal grain as described above, the volume of the crystal grain is also reduced. On the whole the value of KuV decreases, thereby making it difficult to ensure thermal stability. Also, since the deviation value of the crystal grain is increased, signal-to-noise ratio (SNR) is lowered.

Currently, a CoCr alloy-based ferromagnetic material is generally used as a recording layer material in a magnetic recording medium. FIG. 1 is a SEM photograph of a plane on which a CoCr alloy-based material used for a conventional magnetic recording layer is deposited. Referring to FIG. 1, the dark portions are magnetic crystal grains in which recording is actually performed. The bright portions between crystal grains are Cr-rich phases in which the Cr content is greater than that of Co, which phases serve as compositional segregation phases. The Cr-rich phase magnetically isolates crystal grains.

Referring to FIG. 1, when forming a magnetic recording layer according to a conventional method, the size and the distribution of crystal grains are not uniform and the interface thereof is not uniform, which causes media noise. Also, when using the CoCr alloy-based material, if the size of crystal grains is decreased to 5 nm or less in order to reduce noise, magnetization is unstable even at room temperature, so that information may be destroyed.

Consequently, when reducing noise by decreasing the size of the crystal grains, it is very difficult to ensure thermal stability. This problem can be solved by introducing a magnetic material having a high magnetic anisotropic energy. Examples of the magnetic material having a high magnetic anisotropic energy include alloys, such as FePt, CoPd, CoPt, NdFeB, Co/Pd multi-layer film, Co/Pt multi-layer film, Fe/Pt multi-layer film, and Fe/Pd multi-layer film. Such materials cannot form a crystal structure which is completely isolated physically and magnetically by a physical depositing method alone. In other words, the media noise is mainly induced from a zigzag-shaped magnetic wall generated in a transition region that is a boundary portion of bits. The zigzag-shaped magnetic wall vibrates violently as the magnetic exchange bonds (magnetic interaction) between magnetic crystal grains are strong. Thus, to reduce media noise, it is necessary to eliminate the magnetic interaction between crystal grains to magnetically isolate each of the magnetic crystal grains. As described above, since there is a Cr-rich phase in which the content of Cr is significantly greater than that of Co, as a compositional segregation phase in a conventional CoCr alloy, the crystal grains can be magnetically isolated. However, a material having a high magnetic anisotropic energy, such as FePt, does not have a compositional segregation phase, and thus, cannot prevent interactions between crystal grains. Also, some CoCr alloys having a high magnetic aniosotropic energy do not achieve complete segregation, and thus, cannot prevent interactions between crystal grains. Accordingly, noise may be increased.

### SUMMARY OF THE INVENTION

The present invention provides a magnetic recording medium having a uniform distribution of sizes of the crystal grains, having uniform interfaces of the crystal grains, and having high thermal stability in spite of the presence of fine and uniform crystal grains. Also, the magnetic recording medium of the present invention has high density recording characteristics and superior SNR characteristics because the crystal grains are magnetically isolated.

According to a first aspect, the present invention provides a magnetic recording medium having a magnetic recording layer containing magnetic crystal grains and a substrate supporting the magnetic recording layer. The magnetic recording layer is composed of a porous crystal isolating membrane having micropores capable of magnetically or physically isolating the magnetic crystal grains.

### BRIEF DESCRIPTION OF THE DRAWINGS

The above and other features and advantages of the present invention will become more apparent by describing in detail exemplary embodiments thereof with reference to the attached drawings in which:

FIG. 1 is a SEM photograph of a plane on which a CoCr alloy-based material used for a conventional magnetic recording layer is deposited;

FIG. 2 is a SEM photograph of a crystal isolating membrane for use in a magnetic recording medium according to an embodiment of the present invention;

FIG. 3 is a cross-sectional view illustrating schematically the structure of a magnetic recording medium according to an embodiment of the present invention;

FIG. 4 is a schematic cross-sectional view of a magnetic recording medium according to Example 1 of the present invention;

FIG. 5 is a schematic cross-sectional view of a magnetic recording medium according to Example 3 of the present invention;

FIG. 6 is a schematic cross-sectional view of a magnetic recording medium according to Example 5 of the present invention; and

FIG. 7 is a schematic cross-sectional view of a magnetic recording medium according to Example 7 of the present invention.

### DETAILED DESCRIPTION OF THE INVENTION

The present invention will now be described in greater detail by reference to the drawings. However, the present invention should not be construed as being limited thereto.

A magnetic recording layer of a magnetic recording medium according to an embodiment of the present invention is composed of a crystal isolating membrane in the form of a template having previously formed micropores so as to provide a magnetic recording layer having fine, uniform crystal grains. A magnetic recording material including magnetic crystal grains is impregnated into the pores so as to prevent physical and magnetic interactions between crystal grains, and the boundary portion interface of bits is allowed in advance to be uniform, thereby reducing noise.

Meanwhile, the standard deviation of the pore size may be 30% or less of the size of the crystal grains of the magnetic recording material to provide for a uniform crystal grain size, thereby reducing noise.

As described above, when using a material having high a magnetic anisotropic energy, such as FePt, because there is no compositional segregation phase, interaction between crystal grains cannot be prevented. To solve this problem, the porous crystal isolating membrane can be used to prevent physical and magnetic interactions between crystal grains.

The recording material for use in the present invention may employ conventional recording materials, and examples thereof include a transition metal element selected from Co, Fe, Ni, Cr, Pt, Pd, Ti, Ta, Ru, Si, Al, Nb, B, Nd, Sm, and Pr, an alloy thereof, and an alloy containing at least one transition metal element of Co and Fe and at least one noble metal element selected from Pt and Pd.

The micropore of the porous crystal isolating membrane may have a diameter of 2-100 nm. When the diameter of the micropore is less than 2 nm, it is difficult to ensure thermal stability. When the diameter of the micropore is greater than 100 nm, it is difficult to obtain a high density recording. Meanwhile, when using a recording material having a very high magnetic anisotropic energy as the recording material, the diameter of the micropore may be 3-5 nm, since thermal stability and a super high density recording characteristic of 400 Gb/in² or greater can be obtained within the above range.

Also, an aspect ratio of the micropore may be 0.01-1000. Herein, the aspect ratio means the ratio of the depth of the pore to the diameter of the pore. For example, an aspect ratio of 10 indicates a pore diameter of 2 nm and a pore depth of 20 nm. When the aspect ratio is less than 0.01, since the depth of the pore is too shallow, it is difficult to sufficiently impregnate the recording material. When the aspect ratio is greater than 1000, it is difficult to uniformly impregnate the recording material.

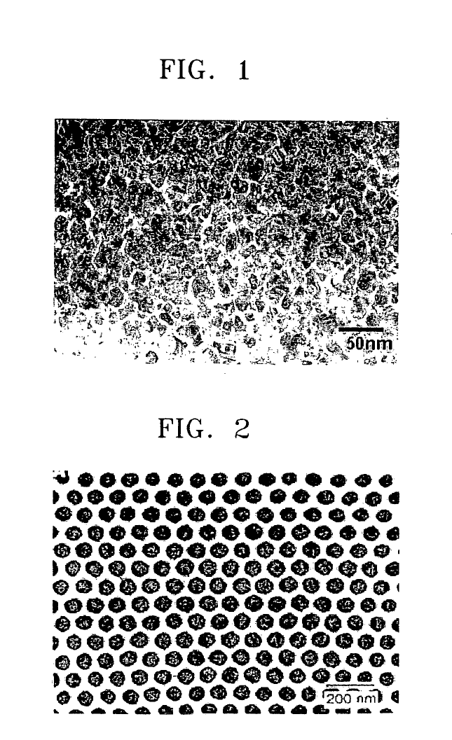

FIG. 2 is a SEM photograph of the crystal isolating membrane for use in the magnetic recording medium according to an embodiment of the present invention. The porous crystal isolating membrane may be composed of a material in which micropores are magnetically isolated, for example, aluminium oxide. When preparing the porous crystal isolating membrane from aluminium oxide, anodic oxidation which is a method known generally in the art may be used. In anodic oxidation, when Al is used as an anode and electricity is generated, oxygen is generated in the anode so as to oxidize the Al surface to form a porous Al₂O₃ layer.

Although It is sufficient if the magnetic anisotropic energy (Ku) of the recording material is 5×10⁵ erg/cm³, a recording material having a higher magnetic anisotropic energy may be used in order to ensure thermal stability as the crystal grain size decreases. When the crystal grain size is 5 nm or less, the magnetic anisotropic energy may be 2.0×10⁷ erg/cm³. Examples of the alloy having a very high magnetic anoisotropic energy include FePt, CoPd, CoPt, and NdFeB.

The magnetic recording medium according to an embodiment of the present invention may further include an under layer between the magnetic recording layer and the substrate. The under layer improves the crystal orientation of the magnetic recording layer and may be composed of Ti, Pt, Au, Pd, Ta, Cu, Ru, Ag, Au, B, Nd, Nb, Cr, Co, Ni, Fe, Al, Si, Zr, Mo, Pr, C, or an alloy thereof.

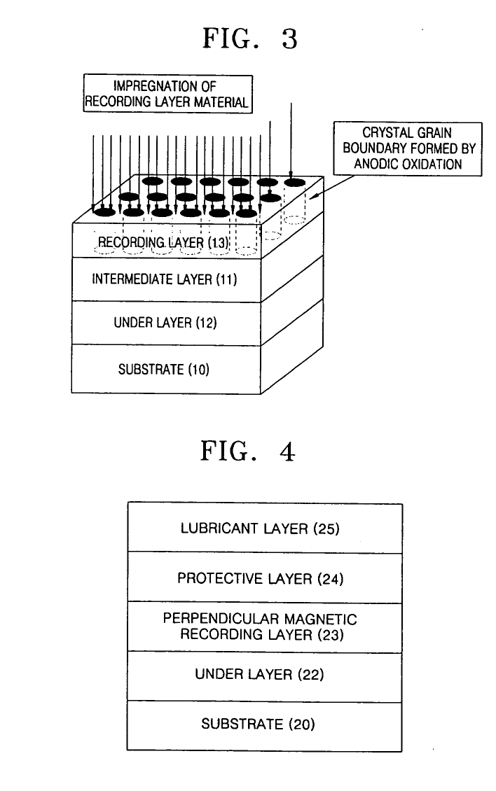

FIG. 3 is a cross-sectional view schematically illustrating the structure of the magnetic recording medium according to an embodiment of the present invention. In the magnetic recording medium, an under layer 12 for improving the crystal orientation of a perpendicular magnetic recording layer 13, an intermediate layer 11 for reducing the difference in crystal structure between the under layer 12 and the recording layer 13 so as to improve the crystallinity of the perpendicular magnetic recording layer 13, and the perpendicular magnetic recording layer 13 composed of a crystal isolating membrane are sequentially deposited on a glass or an aluminium based alloy substrate 10. In the medium, a magnetization easy axis of the perpendicular magnetic recording layer 13 is arranged perpendicularly to the plane of the membrane by the under layer 12, and thus the perpendicular magnetic recording layer 13 has perpendicular magnetic anisotropic energy. As a result, it is possible to perpendicularly record information by perpendicular magnetic field components of a single pole head.

A glass substrate, an Al—Mg based substrate having a NiP amorphous film coated thereon, a thermally oxidized Si substrate, and the like are generally used as the substrate 10, and the under layer 12 is formed by depositing Ti, etc., on the substrate 10 by a sputtering method or other physical depositing method. The thickness of the under layer 12 is in the range of 1-200 nm. The magnetic recording layer 13 is formed on the under layer 12. The magnetic recording layer 13 is formed by first forming an Al layer using a sputtering method, and then forming micropores via anodic oxidation, and then impregnating the recording material into the micropores. Plating, CVD, PVD, sputtering, sol-gel method, and the like may be used for impregnation. When the depth of the pore is great, a plating method may be used and when the depth of the pore is shallow, a sputtering method may be used to simplify the preparation process.

The magnetic recording medium according to an embodiment of the present invention may be a longitudinal magnetic recording medium as well as a perpendicular magnetic recording medium. FIG. 4 is a schematic cross-sectional view of a perpendicular magnetic recording medium according to an embodiment of the present invention. In the medium, an under layer 22 which improves perpendicular orientation of a recording and reproducing layer, a perpendicular magnetic recording layer 23 which is composed of a crystal isolating membrane, a protective layer 24 which protects the perpendicular magnetic recording layer from oxidation and external impacts, and a lubricant layer 25 which prevents a head slider for recording and reproducing information from colliding against the medium and inducing a smooth slide of the head slider are sequentially deposited on a substrate 20 of a glass or an aluminium based alloy.

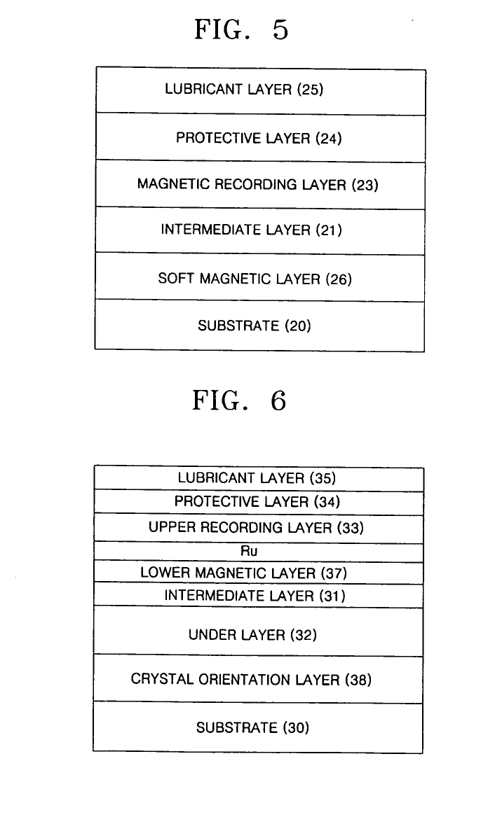

The magnetic recording medium according to another embodiment of the present invention may further include a soft magnetic layer between the recording layer and the substrate. The soft magnetic layer functions as a return path for the magnetic field in the perpendicular magnetic recording medium to form a magnetic path for the perpendicular magnetic field. For example, FeSiAl, a NiFe alloy, or a CoZr alloy may be used for the soft magnetic layer. FIG. 5 is a schematic cross-sectional view of a perpendicular magnetic recording medium, including a soft magnetic layer 26 and an intermediate layer 21.

FIG. 6 is a schematic cross-sectional view of a longitudinal magnetic recording medium according to another embodiment of the present invention including all of an intermediate layer 31, an under layer 32, and a crystal orientation layer 38. The recording layer is divided into an upper recording layer 33 and a lower magnetic layer 37, and a Ru layer is placed between them. The Ru layer is deposited to reduce the effect of an antimagnetic field by decreasing the thickness of the lower magnetic layer 37. In the magnetic recording medium, either or both of the upper recording layer 33 and the lower magnetic layer 37 may be composed of a crystal isolating membrane.

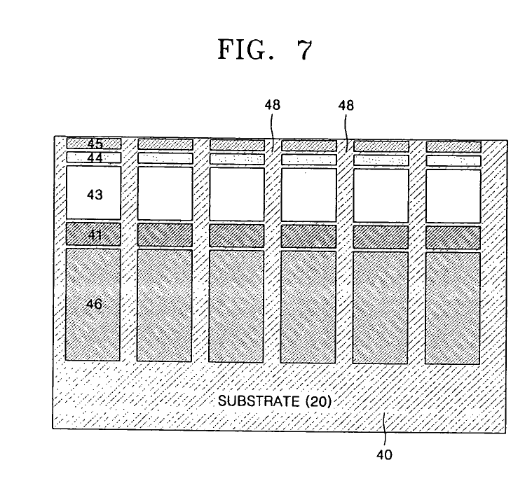

Meanwhile, the magnetic recording medium may be prepared by allowing all layers except for the substrate, for example, the soft magnetic layer, the intermediate layer, and the under layer to be composed of a crystal isolating membrane in the form of one body, and then sequentially impregnating materials composing the respective layers. An embodiment of a recording medium using the crystal isolating membrane in all layers except for the substrate is illustrated in FIG. 7. The recording medium is prepared by forming a crystal isolating membrane 48 as one body on a substrate 40 and sequentially impregnating a soft magnetic layer 46, an intermediate layer 41, a recording layer 43, a protective layer 44, and a lubricant layer 45.

The present invention will be described in greater detail with reference to the following examples. The following examples are for illustrative purposes and are not intended to limit the scope of the invention.

### EXAMPLE 1

An under layer of Ti was deposited to a thickness of 50 nm on a glass substrate having a thickness of 0.635 mm and Al was sputtered thereon to a thickness of 10 nm. Then, micropores having a diameter of 5 nm (standard deviation: 20%) were formed by anodic oxidation so as to have an aspect ratio of 2. Then, FePt which is a recording material was impregnated into the pores using a sputtering method, and then, a carbon based film having a thickness of 10 nm as a protective layer and a Z-DOL (0.04%) (available from Ausimont) layer having a thickness of 2 nm as a lubricant layer were deposited thereon to prepare a magnetic recording medium.

### EXAMPLE 2

A magnetic recording medium was prepared in the same manner as in Example 1, except that an Al layer having a thickness of 5 nm was formed and the aspect ratio was 1.

### EXAMPLE 3

A magnetic recording medium was prepared in the same manner as in Example 1, except that a Pt intermediate layer having a thickness of 5 nm was deposited instead of the under layer, and a NiFe soft magnetic layer having a thickness of 150 nm was further formed between the intermediate layer and the substrate.

### EXAMPLE 4

An under layer of Ti was deposited to a thickness of 50 nm on a glass substrate having a thickness of 0.635 mm, a Pt intermediate layer was deposited to a thickness of 20 nm, and Al was sputtered thereon to a thickness of 20 nm. Then, micropores having a diameter of 2 nm were formed by anodic oxidation so as to have an aspect ratio of 10. Then, FePt which is a recording material was impregnated into the pores using an electrical plating method. Then, a carbon based film having a thickness of 10 nm as a protective layer and a Z-DOL (0.04%) (available from Ausimont) layer having a thickness of 2 nm as a lubricant layer were deposited thereon to prepare a magnetic recording medium.

### EXAMPLE 5

A Ta crystal orientation layer having a thickness of 5 nm was deposited on a glass substrate having a thickness of 0.635 mm, and then, a Ti under layer having a thickness of 50 nm was deposited thereon. Then, a Pt intermediate layer having a thickness of 5 nm was deposited, and a CoCrPt layer having a thickness of 20 nm as a lower magnetic layer and a Ru layer having a thickness of 5 nm were sequentially deposited. Al was sputtered thereon to a thickness of 20 nm, and then, micropores having a diameter of 5 nm were formed by anodic oxidation so as to have an aspect ratio of 4. Then, CoCrPt which is a recording material was impregnated into the pores using an electrical plating method, and then, a carbon based film having a thickness of 10 nm as a protective layer and a Z-DOL (0.04%) (available from Ausimont) layer having a thickness of 2 nm as a lubricant layer were deposited thereon to prepare a magnetic recording medium.

### EXAMPLE 6

A magnetic recording medium was prepared in the same manner as in Example 4, except that a micropore having a diameter of 20 nm so as to have an aspect ratio of 1 and a CoCr based alloy was used as a recording material.

### EXAMPLE 7

Al was sputtered to a thickness of 180 nm on a glass substrate having a thickness of 0.635 mm, and then, micropores having a diameter of 5 nm were formed by anodic oxidation so as to have an aspect ratio of 30. Then, a NiFe soft magnetic layer material was impregnated into the pores to a thickness of 150 nm, and then, a Ru layer having a thickness of 20 nm as an intermediate layer and a layer of CoPt which is a recording material having a thickness of 10 nm were sequentially impregnated and deposited. Finally, the surface of the deposit was planarized, and then, a carbon based film having a thickness of 10 nm as a protective layer and a Z-DOL (0.04%) (available from Ausimont) layer having a thickness of 2 nm as a lubricant layer were deposited thereon to prepare a magnetic recording medium.

As described above, magnetic recording media according to embodiments of the present invention can adjust the boundary surface of bits very uniformly to reduce noise since the crystal grains of the recording material are very fine and uniform. Also, a high density recording of 400 Gb/in² or greater can be obtained since the size of the crystal grain may be controlled to 5 nm or less. Also, even though using a material having a very high magnetic anisotropic energy as a recording material in order to ensure thermal stability, crystal grains of the recording material can be physically and magnetically isolated, thereby reducing noise.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A magnetic recording medium comprising a magnetic recording layer and a substrate supporting the magnetic recording layer, said magnetic recording layer comprising magnetic crystal grains,
wherein the magnetic recording layer is composed of a porous crystal isolating membrane having micropores capable of magnetically and physically isolating said magnetic crystal grains.

2. The magnetic recording medium of claim 1, wherein said micropores are of a size distribution having a standard deviation of not greater than 30% of the size of said magnetic crystal grains.

3. The magnetic recording medium of claim 1, wherein a transition metal element selected from the group consisting of Co, Fe, Ni, Cr, Pt, Pd, Ti, Ta, Ru, Si, Al, Nb, B, Nd, Sm and Pr or an alloy thereof is impregnated into the micropores.

4. The magnetic recording medium of claim 1, wherein an alloy containing at least one transition metal element selected from the group consisting of Co and Fe and at least one noble metal element selected from the group consisting of Pt and Pd is impregnated into the pores.

5. The magnetic recording medium of claim 1, wherein said micropores have a diameter of 2-100 nm.

6. The magnetic recording medium of claim 1, wherein said micropores have a diameter of 3-5 nm.

7. The magnetic recording medium of claim 1, wherein said micropores have an aspect ratio of 0.01-1000.

8. The magnetic recording medium of claim 1, wherein said porous crystal isolating membrane is composed of aluminum oxide.

9. The magnetic recording medium of claim 1, wherein said magnetic recording layer comprises an alloy having a magnetic anisotropic energy of 5.0×10⁵ erg/cm³ or greater.

10. The magnetic recording medium of claim 1, wherein said magnetic recording layer comprises an alloy having a magnetic anisotropic energy of 2.0×10⁷ erg/cm³ or greater.

11. The magnetic recording medium of claim 1, wherein said magnetic recording layer comprises an alloy selected from the group consisting of FePt, CoPd, CoPt and NdFeB.

12. The magnetic recording medium of claim 1, further comprising an under layer arranged between the magnetic recording layer and the substrate.

13. The magnetic recording medium of claim 12, wherein the magnetic recording layer is adapted for perpendicular magnetic recording.

14. The magnetic recording medium of claim 12, wherein the magnetic recording layer is adapted for longitudinal magnetic recording.

15. The magnetic recording medium of claim 1, further comprising a soft magnetic layer arranged between the magnetic recording layer and the substrate.

16. The magnetic recording medium of claim 12, wherein the under layer is composed of a porous crystal isolating membrane having micropores capable of magnetically and physically isolating said magnetic crystal grains.

17. The magnetic recording medium of claim 1-5, wherein the soft magnetic layer is composed of a porous crystal isolating membrane having micropores capable of magnetically and physically isolating said magnetic crystal grains.

18. The magnetic recording medium of claim 16, wherein a transition metal element selected from the group consisting of Ti, Pt, Au, Pd, Ta, Cu, Ru, Ag, Au, B, Nd, Nb, Cr, Co, Ni, Fe, Al, Si, Zr, Mo, Pr and C or an alloy thereof is impregnated into micropores of the porous crystal isolating membrane composing the under layer.

19. The magnetic recording medium of claim 17, wherein FeSiAl, a NiFe alloy, or a CoZr alloy is impregnated into micropores of the porous crystal isolating membrane composing the soft magnetic layer.

20. The magnetic recording medium of claim 17, wherein a material having an exchange magnetic anisotropic effect or an antiferromagnetic bonding structure is impregnated into micropores of the porous crystal isolating membrane of the soft magnetic layer.
